(19) United States
(12) Patent Application Publication
(10) Pub. No.: US 2026/0141578 A1
(43) Pub. Date: May 21, 2026

(54) APPARATUS AND METHOD WITH IMAGE GENERATION

(71) Applicant: Samsung Electronics Co., Ltd., Suwon-si (KR)

(72) Inventors: Hui LI, Xi’an (CN); Peng DU, Xi’an (CN); Zidong GUO, Xi’an (CN); Han XU, Xi’an (CN); Ran YANG, Xi’an (CN); Dongwook LEE, Suwon-si (KR); Dae Hyun JI, Suwon-si (KR); Paulbarom JEON, Suwon-si (KR)

(73) Assignee: Samsung Electronics Co., Ltd., Suwon-si (KR)

(21) Appl. No.: 19/373,045

(22) Filed: Oct. 29, 2025

(30) Foreign Application Priority Data
Nov. 15, 2024 (CN) 202411639182.7
Jul. 28, 2025 (KR) 10-2025-0102206

(51) Int. Cl. G06T 11/00; G06T 5/70; G06T 7/73; G06V 10/74; G06V 10/77; G06V 10/774

(52) U.S. Cl. CPC G06T 11/00; G06T 5/70; G06T 7/73; G06V 10/761; G06V 10/7715; G06V 10/774; G06T 2207/20081

(57) ABSTRACT

An apparatus includes one or more processors comprising processing circuitry, and memory comprising one or more storage media storing instructions that, when executed individually or collectively by the one or more processors, cause the apparatus to generate a feature map from an input image, generate a coordinate combined feature map by concatenating the feature map and a coordinate map indicating a location of a feature point of the feature map, predict noise of the feature map using a noise prediction model, based on the coordinate combined feature map, generate a denoised feature map by denoising the feature map based on the predicted noise, and generate a target image based on the denoised feature map.

### CROSS-REFERENCE TO RELATED APPLICATIONS

This application claims the benefit under 35 USC § 119 (a) of Chinese Patent Application No. 202411639182.7, filed on Nov. 15, 2024 in the China National Intellectual Property Administration, and Korean Patent Application No. 10-2025-0102206, filed on Jul. 28, 2025 in the Korean Intellectual Property Office, the entire disclosures of which are incorporated herein by reference for all purposes.

### BACKGROUND

### 1. Field

The disclosure relates to an apparatus and method with image generation.

### 2. Description of Related Art

Methods for image generation using machine learning models may include an image generation method using a generative adversarial network (GAN) and a diffusion model based-image generation method. A typical image generation method using GAN may lack diversity and require a lot of resources to train the GAN. A diffusion model based-image generation method may have excellent scalability when the diffusion model is based on a pure transformer architecture. However, a typical image generation method using diffusion models based on pure transformer architecture may have limitations in that images are generated with the same resolution of training image data used for training.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an apparatus includes one or more processors comprising processing circuitry, and memory comprising one or more storage media storing instructions that, when executed individually or collectively by the one or more processors, cause the apparatus to generate a feature map from an input image, generate a coordinate combined feature map by concatenating the feature map and a coordinate map indicating a location of a feature point of the feature map, predict noise of the feature map using a noise prediction model, based on the coordinate combined feature map, generate a denoised feature map by denoising the feature map based on the predicted noise, and generate a target image based on the denoised feature map.

For the predicting of the noise, the execution of the instructions may cause the apparatus to determine one or more input tokens from the feature map by performing a convolution operation on the coordinate combined feature map, determine one or more output tokens by performing an attention operation on the one or more input tokens, and predict the predicted noise using the noise prediction model to which the one or more output tokens is input.

For the determining of the one or more output tokens, the execution of the instructions may cause the apparatus to map each token comprised in the one or more input tokens to a query, a key and a value, determine an attention output by performing an attention operation on each token based on the query, the key and the value, and map the attention output to the one or more output tokens.

For the predicting of the noise, the execution of the instructions may cause the apparatus to predict a first noise of the feature map using the noise prediction model to which the one or more output tokens is input, generate a first denoised feature map based on the feature map and the first noise, generate a second denoised feature map by enlarging the first denoised feature map to a predetermined size, generate a feature map to which noise is added by adding noise to the second denoised feature map, determine a second noise based on a difference between the first denoised feature map and the feature map to which noise is added, and determine the second noise as noise of the feature map.

For the determining of the one or more input tokens, the execution of the instructions may cause the apparatus to perform padding on the coordinate combined feature map, and perform the convolution operation on the padded coordinate combined feature map.

For the determining of the one or more input tokens, the execution of the instructions may cause the apparatus to determine the one or more input tokens by transforming a result of the convolution operation into a lower-dimensional vector.

For the generating of the target image, the execution of the instructions may cause the apparatus to generate the target image by decoding the denoised feature map using a variational autoencoder (VAE).

The feature map may be generated by adding noise to a feature map acquired from a training image selected from a training image set, and the execution of the instructions may cause the apparatus to train the noise prediction model based on the predicted noise and the noise added to the feature map.

In one or more general aspects, an apparatus includes one or more processors comprising processing circuitry, and memory comprising one or more storage media storing instructions that, when executed individually or collectively by the one or more processors, cause the apparatus to generate a feature map to which a first noise is added by adding noise to a feature map acquired from a training image selected from a training image set, generate a coordinate combined feature map by concatenating the feature map comprising the noise and a coordinate map indicating a location of a feature point of the feature map comprising the noise, predict noise of the feature map using a noise prediction model, based on the coordinate combined feature map, and train the noise prediction model based on the predicted noise and the noise added to the feature map.

For the training of the noise prediction model, the execution of the instructions may cause the apparatus to train the noise prediction model by adjusting one or more parameters comprised in the noise prediction model based on reducing a difference between the predicted noise and the noise added to the feature map.

For the predicting of the noise, the execution of the instructions may cause the apparatus to determine one or more input tokens from the feature map based on performing a convolution operation on the coordinate combined feature map, determine one or more output tokens by performing an attention operation on the one or more input tokens, and determine the predicted noise from the noise prediction model to which the one or more output tokens is input.

For the determining of the one or more output tokens, the execution of the instructions may cause the apparatus to map each token comprised in the one or more input tokens to a query, a key and a value, determine an attention operation result token by performing an attention operation on each token based on the query, the key, and the value, and map the attention operation result token to the one or more output tokens.

For the predicting of the noise, the execution of the instructions may cause the apparatus to predict a first noise which is a result of predicting noise of the feature map from the noise prediction model to which the one or more output tokens is input, generate a first denoised feature map based on the feature map and the first noise, generate a second denoised feature map by enlarging the first denoised feature map to a predetermined size, generate a feature map to which a second noise is added by adding noise to the second denoised feature map, determine the second noise based on a difference between the first denoised feature map and the feature map to which the second noise is added, and determine the second noise as noise of the feature map comprising the noise.

The execution of the instructions may cause the apparatus to select one or more training image groups from the training image set, and generate the training image from the training image set by sampling an image comprised in the training image group, wherein the training image group may include a first training image group and a second training image group different from the first training image group, and an image comprised in the first training image group may have a first aspect ratio, an image comprised in the second training image group may have a second aspect ratio, and the first aspect ratio may be greater than the second aspect ratio.

The execution of the instructions may cause the apparatus to preprocess the training image by performing either one or both of a first preprocessing performed according to a first performance probability indicating a probability that preprocessing is to be performed and a second preprocessing performed according to a second performance probability different from the first performance probability, wherein the first preprocessing performed according to the first performance probability may include dividing a center of the training image into blocks of a predetermined size, and the second preprocessing performed according to the second performance probability may adjust a size of the training image to be less than or equal to a threshold value by adjusting a height of the training image to a predetermined length and adjusting a width of the training image to correspond to the predetermined height while maintaining an aspect ratio of the training image.

In one or more general aspects, a processor-implemented method includes generating a feature map from an input image, generating a coordinate combined feature map by concatenating the feature map and a coordinate map indicating a location of a feature point of the feature map, predicting noise of the feature map using a noise prediction model, based on the coordinate combined feature map, generating a denoised feature map by denoising the feature map based on the predicted noise, and generating a target image based on the denoised feature map.

The predicting of the noise may include determining one or more input tokens from the feature map by performing a convolution operation on the coordinate combined feature map, determining one or more output tokens by performing an attention operation on the one or more input tokens, and predicting the predicted noise using the noise prediction model to which the at least one output token is input.

The determining of the one or more output tokens may include mapping each token comprised in the one or more input tokens to a query, a key and a value, determining an attention output by performing an attention operation on each token based on the query, the key and the value, and mapping the attention output to the one or more output tokens.

The predicting of the noise may include predicting a first noise of the feature map using the noise prediction model to which the one or more output tokens is input, generating a first denoised feature map based on the feature map and the first noise, generating a second denoised feature map by enlarging the first denoised feature map to a predetermined size, generating a feature map to which noise is added by adding noise to the second denoised feature map, determining a second noise based on a difference between the first denoised feature map and the feature map to which noise is added, and determining the second noise as noise of the feature map.

In one or more general aspects, a non-transitory computer-readable storage medium may store instructions that, when executed by one or more processors, configure the one or more processors to perform any one, any combination, or all of operations and/or methods disclosed herein.

Other features and aspects will be apparent from the following detailed description, the drawings, and the claims.

### BRIEF DESCRIPTION OF THE DRAWINGS

FIG. 1 illustrates an example of operations of an image generation method, according to one or more embodiments.

FIG. 2 illustrates an example of a denoising process, according to one or more embodiments.

FIG. 3 illustrates an example of operations of a training method for training a noise prediction model, according to one or more embodiments.

FIG. 4 illustrates an example of a noise prediction model, according to one or more embodiments.

FIG. 5 illustrates an example of an input embedding module of a noise prediction model, according to one or more embodiments.

FIG. 6 illustrates an example of an attention process performed in a diffusion noise prediction model, according to one or more embodiments.

FIG. 7 illustrates an example of a training apparatus, according to one or more embodiments.

FIG. 8 illustrates an example of an image generation apparatus, according to one or more embodiments.

FIG. 9 illustrates an example of components of an image generation apparatus, according to one or more embodiments.

FIG. 10 illustrates an example of components of a training apparatus, according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms used herein including technical or scientific terms have the same meanings as commonly understood by one of ordinary skill in the art to which the present disclosure pertains and specifically in the context on an understanding of the present disclosure. Terms, such as those defined in commonly used dictionaries, should be construed to have meanings matching with contextual meanings in the relevant art and specifically in the context of the present disclosure, and are not to be construed as an ideal or excessively formal meaning unless otherwise defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as “in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Hereinafter, examples will be described in detail with reference to the accompanying drawings. When describing the examples with reference to the accompanying drawings, like reference numerals refer to like components and a repeated description related thereto will be omitted.

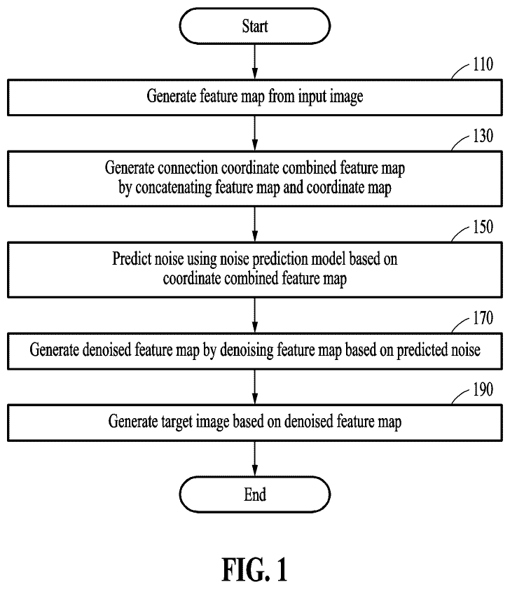

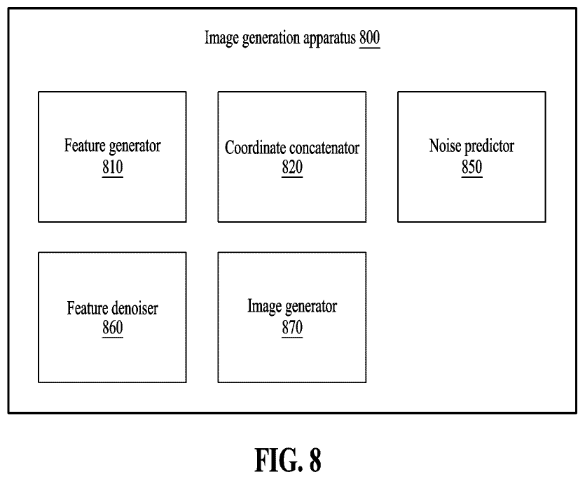

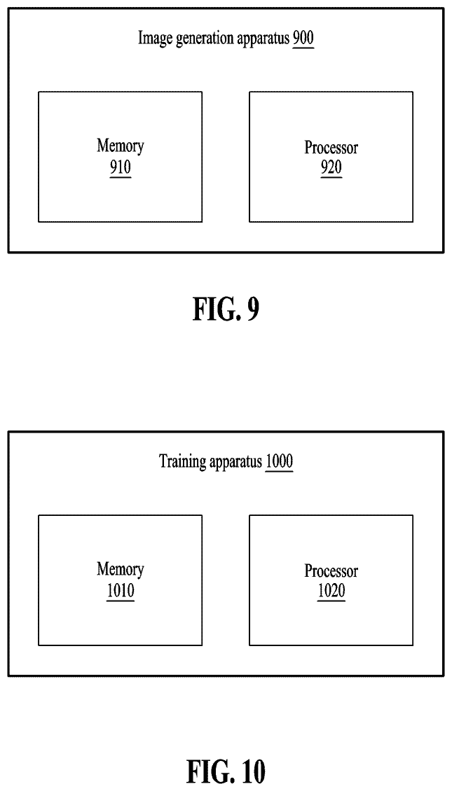

FIG. 1 illustrates an example of operations of an image generation method, according to one or more embodiments. The operations of the image generation method may be performed by an image generation apparatus (e.g., an image generation apparatus 800 of FIG. 8 and/or an image generation apparatus 900 of FIG. 9).

The image generation apparatus described herein may generate a high-resolution image having a dynamic size. The image generation apparatus of one or more embodiments may train a machine learning model used for image generation without collecting high-resolution training image data for training, at a lower cost than typical schemes (e.g., typical apparatuses that collect and use the high-resolution training image data for the training). The machine learning model used for image generation may be a noise prediction model based on a diffusion transformer (DiT) model, which is a combination of a diffusion model and a transformer model. A DiT model based-noise prediction model may be a model for image and/or video generation. The DiT model based-noise prediction model may gradually introduce noise into an input image, remove noise from the input image containing noise using a trained neural network, and generate a target image or target video using the input image from which noise has been removed.

Referring to FIG. 1, in operation 110, the image generation apparatus may generate a feature map from an input image. The image generation apparatus may generate a latent feature map from an input image. For example, the image generation apparatus may input the input image to an encoder (e.g., an autoencoder) and generate a latent feature map from the encoder.

In operation 130, the image generation apparatus may generate a connection coordinate combined feature map by concatenating the feature map and a coordinate map. Concatenation may be a process of connecting feature maps and coordinate maps according to a predetermined dimension or scheme. The coordinate map may be used to provide location information of a feature point within a feature map. A feature point may be an intentional point (or part of an area) in an input image or a point (or part of an area) in an input image representing a structural feature. A size of a coordinate map may be the same as a size of a feature map or a size of a feature map including noise.

The image generation apparatus may normalize a coordinate map to facilitate coordinate determination, and generate a connection coordinate combined feature map by concatenating the normalized coordinate map and the feature map. For example, when a size of the feature map is [0, 1], the image generation apparatus may normalize a size of the coordinate map to [0, 1], which is the same size as the feature map, but examples are not limited thereto. In response to normalizing the coordinate map, the connection coordinate combined feature map may be generated by concatenating the normalized coordinate map and feature map having the size of [0, 1]. The connection coordinate combined feature map may provide coordinate information of feature points within the feature map and improve the resolution of an output image to be output.

In operation 150, the image generation apparatus may predict noise using a noise prediction model based on the coordinate combined feature map. The image generation apparatus may determine at least one token from the feature map by performing a convolution operation on the coordinate combined feature map. The image generation apparatus may determine at least one output token by performing attention (e.g., an attention operation) on the at least one token. For example, the image generation apparatus may perform self-attention (e.g., a self-attention operation) on the tokens. By not embedding each token individually, the image generation apparatus of one or more embodiments may improve the speed of determining an output token.

The image generation apparatus may map each token included in the at least one token to a query, a key, and a value. The image generation apparatus may determine an attention output by performing an attention operation for each token based on the query, key, and value, and map the determined attention output to at least one output token.

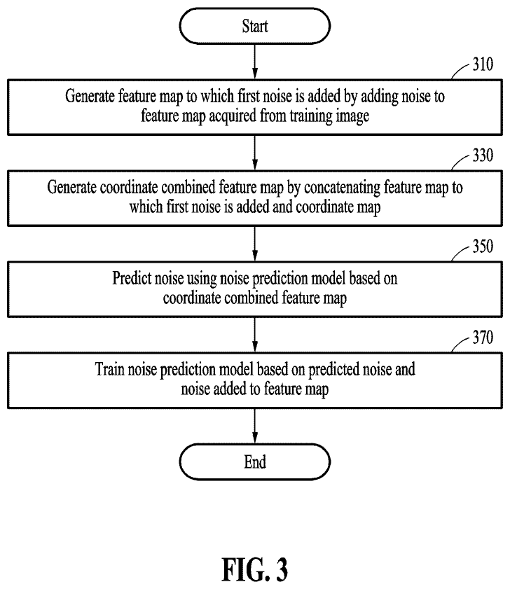

The image generation apparatus may predict noise using the noise prediction model to which at least one output token is input. For example, the image generation apparatus may determine a first noise, which is a result of predicting noise of a feature map from the noise prediction model to which the at least one output token is input, and generate a first denoised feature map based on the feature map and the first noise. The image generation apparatus may generate a second denoised feature map by enlarging the first denoised feature map to a predetermined size, and generate a feature map to which noise is added by adding noise to the second denoised feature map. The image generation apparatus may determine a second noise based on a difference between the first denoised feature map and the feature map to which noise is added, and determine the second noise as noise of the feature map. One or more examples of the predicting of the noise using the noise prediction model are described in more detail with reference to FIG. 3.

In operation 170, the image generation apparatus may generate a denoised feature map by denoising the feature map based on the predicted noise. Denoising may be removing (or reverse diffusing) noise predicted from the feature map.

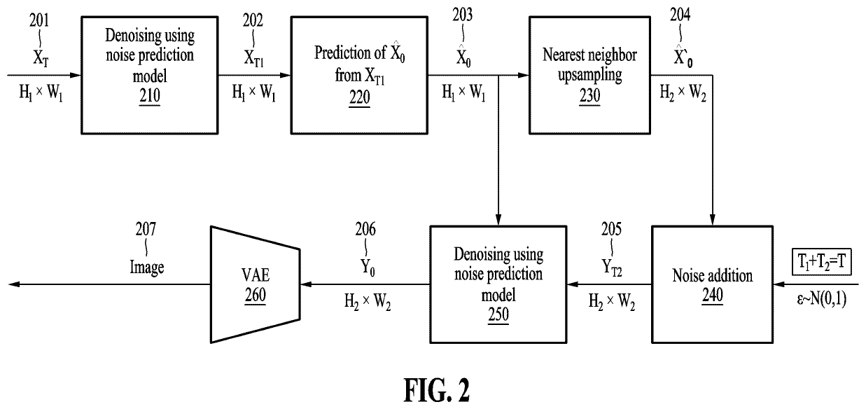

In operation 190, the image generation apparatus may generate a target image based on the denoised feature map. For example, the image generation apparatus may generate a target image by encoding the denoised feature map using a variational autoencoder (VAE). One or more examples of the encoding of the denoised feature map are described in more detail with reference to FIG. 2.

FIG. 2 illustrates an example of a denoising process, according to one or more embodiments.

Referring to FIG. 2, an image generation apparatus (e.g., the image generation apparatus 800 of FIG. 8) may generate a denoised feature map by denoising a feature map based on predicted noise, and generate a target image based on the denoised feature map. The image generation apparatus may generate a target image by encoding the denoised feature map using a VAE.

An image input to the image generation apparatus may be an image of a size of 512×512, and a noise prediction model may be trained to output an image of a size of 256×256 or less, as a non-limiting example.

For example, when a height of the image input to the image generation apparatus is h and a width is w, a size of the input image may be expressed as (512,512). In this example, the size of the feature map (e.g., a latent feature map) generated from the input image may be determined by Equation 1 below, for example.

$$( {H}_{2} , {W}_{2} ) = ceil ( h / 8 , w / 8 ) \qquad Equation 1$$

In Equation 1, H₂ denotes a height of the feature map, W₂ denotes a width of the feature map, ceil denotes a ceiling operator, H₂ may represent a result of performing a ceiling operation on a value of a height h divided by 8, and W₂ may represent a result of performing a ceiling operation on a value of a width w divided by 8. (H₂, W₂) may represent (64, 64) in an example.

The image generation apparatus may reduce the feature map size (H₂, W₂) to (H₁, W₁). For example, when the noise prediction model, which is H₁W₁≤2564, outputs an image of a size less than or equal to 256×256, the image generation apparatus may reduce a feature map of a size of (H₂, W₂)=(64, 64) to a feature map having a size of (H₁, W₁)=(16, 16). Here, H₁ denotes a height of the reduced feature map (or reduced latent feature map), and 1 denotes a width of the reduced feature map (or reduced latent feature map).

The denoising process may include step T₁ and step T₂.

Step T₁ may be a process of generating a guide feature map X_{T}_{₁} 202 using a noise prediction model. The guide feature map X_{T}_{₁} 202 may be a reference feature map that serves as a reference used in a process of processing a feature map by a noise prediction model. In step T₁, white noise X_{T} 201 sampled from a standard normal distribution N(0, 1) may be defined. The size of the white noise X_{T} 201 may be H₁×W₁.

In operation 210, denoised feature maps may be generated using a noise prediction model. At time t=T, . . . T₁, noise may be predicted using the noise prediction model, and denoised feature maps Xₜ₋₁, Xₜ₋₂, Xₜ₋₃, X₁₋₄, . . . , X_{T}_{₂} may be generated by denoising feature maps according to the predicted noise, and this process may be repeated until the guide feature map X_{T}_{₁} 202 is generated. The size of the guide feature map X_{T}_{₁} 202 may be H₁×W₁.

In operation 220, a guide feature map \hat{x}₀ 203 may be predicted from the guide feature map X_{T}_{₁} 202. By inputting the guide feature map X_{T}_{₁} 202 to the noise prediction model, and by going through the same process as the process of generating the denoised feature maps performed in operation 210, the guide feature map \hat{x}₀ 203 may be generated. The size of the guide feature map \hat{x}₀ 203 may be H₁×W₁, and the guide feature map \hat{x}₀ 203 may be used in step T₂.

Step 12 may represent a process of generating an upsampled guide feature map \hat{x}′₀ 204 by enlarging the guide feature map \hat{x}₀ 203 via upsampling (e.g., nearest neighbor upsampling), generating a feature map Y_{T2} 205 including noise of a determined size by adding noise (e.g., Gaussian noise and/or white noise) of the same size, and denoising the feature map Y_{T2} 205.

In operation 230, the image processing apparatus may generate the upsampled guide feature map

$${\hat{x}}_{0}^{′} 204$$

by upsampling (e.g., nearest neighbor upsampling) the quire feature map \hat{x}₀ 203. The size of the upsampled guide feature map

$${\hat{x}}_{0}^{′} 204$$

may be an upsampling result H₂×W₂. H₂×W₂ may represent a greater value than H₃×W₁.

In operation 240, noise may be added to the upsampled guide feature map

$${\hat{x}}_{0}^{′} 204.$$

The image processing apparatus may generate the feature map Y_{T2} 205 including noise of a target size by adding noise T₁+T₂=T to the upsampled guide feature map

$${\hat{x}}_{0}^{′} 204.$$

The size of the feature map Y_{T2} 205 including the noise of the target size may be H₂×W₂.

In operation 250, a denoising process may be performed for time t=T₂, . . . , 1 on the feature map Y_{T2} 205 including the noise of the target size using the noise prediction model. The guide feature map \hat{x}₀ 203 may be used in this process to prevent the noise prediction model from generating uncontrolled feature maps (or patterns). Predicting or generating feature map Y₀ 206 from the feature map Y_{T2} 205 may be expressed by the following process. An average μ(yₜ) and variance σ may be determined for yₜ, which represents a feature map at time t. The average μ(yₜ) may be replaced by Equation 2 below, for example.

$$\hat{μ} ( {y}_{t} ) = μ ( {y}_{t} ) + s σ {∇}_{{\hat{y}}_{0}} ( {‖ Down ( {\hat{y}}_{0} ) - {\hat{x}}_{0} ‖}_{2} ) \qquad Equation 2$$

In Equation 2, \hat{x}₀ 203 denotes a guide feature map, sσ∇_{ŷ}_{₀}(∥Down(ŷₐ)−\hat{x}₀∥₂) denotes a difference between a currently predicted feature map and the guide feature map, μ(yₜ) denotes an average of yₜ, μ(yₜ) denotes a value that replaces the average of yₜ, Down(ŷ₀) denotes a downsampled image, ∇_{ŷ}_{₀} denotes a gradient operator, S: denotes an extent to which is guided by the guide feature map, and σ denotes the variance for yₜ. In response to determining the average μ(yₜ) and the variance σ for yₜ, the feature map yₜ at time t and a denoised feature map yₜ₋₁ in the variance σ state may be generated. In response to the above-described process being performed, Y₀ 206 of size H₂×W₂ may be generated.

In operation 260, the VAE Y₀ 206 may be input and an image 207 (e.g., RGB image) may be generated as a result.

By inputting coordinate information included in the coordinate map together with the feature map to the noise prediction model, the image processing apparatus of one or more embodiments may improve the extrapolation ability of the noise prediction model and generate an image of a predetermined size that is not restricted by resolution and aspect ratio.

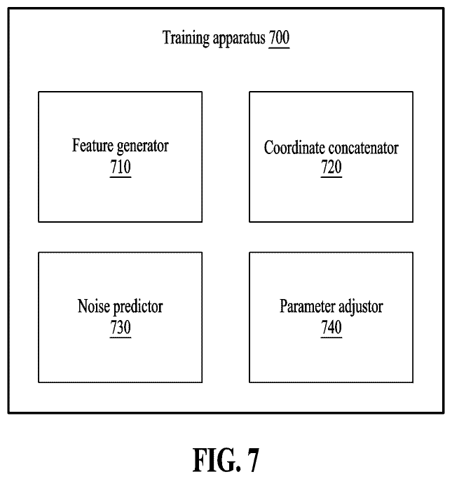

FIG. 3 illustrates an example of operations of a training method for training a noise prediction model, according to one or more embodiments. The operations of the training method for training the noise prediction model may be performed by a training apparatus (e.g., a training apparatus 700 of FIG. 7).

Referring to FIG. 3, in operation 310, the training apparatus may generate a feature map (e.g., a latent feature map) to which a first noise is added by adding noise to a feature map generated from a training image. Noise ε added to the generated feature map may be noise following a standard normal distribution.

The training apparatus may generate a training image from a training image set by selecting at least one training image group from the training image set and sampling an image included in the training image group. The training image group may include a first training image group and a second training image group different from the first training image group. An image included in the first training image group may have a first aspect ratio, an image included in the second training image group may have a second aspect ratio, and the first aspect ratio may be greater than the second aspect ratio. The aspect ratio may be expressed as a ratio value that divides a height of an image by its width. The training apparatus may train the noise prediction model using training images having various aspect ratios, such that the trained noise prediction model is configured to output a target image having an aspect ratio different from the aspect ratio of an input image.

The training apparatus may preprocess a training image. The training apparatus may preprocess a training image by performing at least one of a first preprocessing performed according to a first performance probability (e.g., 30% or 25%) indicating a probability that preprocessing is to be performed and a second preprocessing performed according to a second performance probability (e.g., 70% or 75%) different from the first performance probability. The first preprocessing may be dividing a center of a training image into blocks of a predetermined size. The second preprocessing may be adjusting a size of a training image to be less than or equal to a threshold value by adjusting a height of the training image to a predetermined length and adjusting a width of the training image to correspond to the predetermined height while maintaining an aspect ratio of the training image. For example, the second preprocessing may be center cropping. Center cropping may be a process of cropping to a predetermined size based on a middle region (or center region) of the input image. The training apparatus may input feature maps generated from images of various sizes to the noise prediction model by center cropping the input image. For example, the training apparatus may adjust a size of a training image to be less than or equal to a threshold size by center cropping the size of the training image according to the second performance probability. The training apparatus may center crop each training image into a block of a predetermined size and adjust the size of the training image to be less than or equal to a threshold size while maintaining the aspect ratio of the training image. The threshold size may be a width of the training image having a minimum width among the training images.

The training apparatus may perform preprocessing to vary an aspect ratio of a training image so that the noise prediction model may generate target images of different sizes. The training apparatus may generate a training image from a training image set by selecting at least one training image group from the training image set and sampling an image included in the training image group. The training image group may include a first training image group and a second training image group different from the first training image group. An image included in the first training image group may have a first aspect ratio, an image included in the second training image group may have a second aspect ratio, and the first aspect ratio may be greater than the second aspect ratio.

For example, the training apparatus may divide an entire set of training images into two groups: the first training image group may include training images with an aspect ratio greater than or equal to 1 (h/w≥1) and the second training image group may include training images with an aspect ratio less than 1(h/w<1). h denotes a height of a training image, and w denotes a width of a training image. The training apparatus may randomly select a training image group as a sampling group among the first training images and the second training images during a training process of the noise prediction model. The training apparatus may randomly extract N images from the sampling group. N may represent a predetermined batch size.

For example, the training apparatus may center crop the N images into blocks (e.g., square blocks) of a predetermined size with, for example, a 30% probability. For example, the training apparatus may adjust a height (e.g., a long side) of the sampled N images to “512” while maintaining the aspect ratio, with a probability of 70%. The training apparatus may determine an image with a smallest width among the N images and perform center cropping in a width direction for the remaining images except for the image with the smallest width. In response to performing the center cropping, the training apparatus may resize the N center-cropped images to a size less than or equal to a predetermined threshold size (e.g., 256×256).

In operation 330, the training apparatus may generate a coordinate combined feature map by concatenating the feature map to which the first noise is added and a coordinate map. One or more examples of the coordinate combined feature map are described in detail with reference to FIG. 1, so a repeated description thereof is omitted.

In operation 350, the training apparatus may predict noise using the noise prediction model based on the coordinate combined feature map. The training apparatus may determine at least one token from the feature map based on performing a convolution operation on the coordinate combined feature map. The training apparatus may generate at least one output token by performing an attention operation on the at least one token.

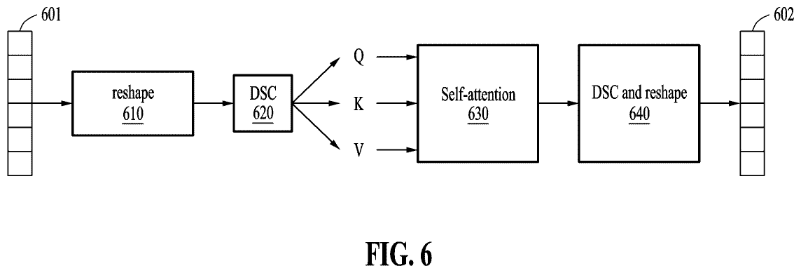

The training apparatus may determine an attention operation result token by mapping each token included in the at least one token to a query, a key, and a value, and performing an attention operation for each token based on the query, key, and value. The training apparatus may map the attention operation result token to at least one output token. The training apparatus may determine a first noise, which is a result of predicting noise of the feature map from the noise prediction model to which at least one output token is input, and generate a first denoised feature map based on the feature map and the first noise. The training apparatus may generate a second denoised feature map by enlarging the first denoised feature map to a predetermined size. The training apparatus may generate a feature map to which a second noise is added by adding noise to the second denoised feature map. One or more examples of the performing of the attention operation are described in more detail with reference to FIG. 6. The training apparatus may predict noise using the noise prediction model to which at least one output token is input. The training apparatus may determine the second noise based on a difference between the first denoised feature map and the feature map to which noise is added, and determine the second noise as noise of the feature map including noise. One or more examples of the predicting of the noise using the noise prediction model are described in detail with reference to FIG. 2, so a repeated description thereof is omitted.

In operation 370, the training apparatus may train the noise prediction model based on the predicted noise and the noise added to the feature map. The training apparatus may train the noise prediction model by adjusting at least one parameter included in the noise prediction model based on reducing a difference between the predicted noise and the noise added to the feature map.

The noise prediction model may be trained through the following process.

A process of training the noise prediction model may include a data preprocessing process, a noise introduction process, and a model training process.

The data preprocessing process may be transforming an input training image or training video into a format that may be used by the model. For example, a training image may be divided into small patches of a fixed size, and the training images divided into small patches may be transformed into feature vectors.

The noise introduction process may be a process in which noise is diffused (or increased) in a feature vector by gradually introducing noise to the feature vector generated through the data preprocessing process.

The model training process may be training the noise prediction model using the feature vector including noise (or in which noise is diffused). In the model training process, noise may be reverse diffused (i.e., noise may be reduced) from the noise-diffused feature vector, and a denoised feature vector may be generated. Parameters included in the noise prediction model may be adjusted to reduce a difference between the feature vector before introducing noise and the denoised feature vector. For example, the parameters of a machine learning model may be adjusted until convergence occurs based on the predicted noise and an actual noise. A size of a loss function based on the parameters may be expressed by Equation 3 below, for example, and a gradient for the loss function may be expressed by Equation 4 below, for example. During the training process, the loss function may be minimized and parameters may be adjusted using gradient descent.

$${‖ ϵ - {ϵ}_{θ} ( \sqrt{{α}_{t}} {x}_{0} + \sqrt{1 - {α}_{t}} ε , t , c ) ‖}^{2} \qquad Equation 3$$

$${∇}_{θ} {‖ ϵ - {ϵ}_{θ} ( \sqrt{{α}_{t}} {x}_{0} + \sqrt{1 - {α}_{t}} ε , t , c ) ‖}^{2} \qquad Equation 4$$

In Equations 3 and 4, ϵ denotes white noise, ∈−∈₀(\sqrt{αₜ}X₀+\sqrt{1−αₜε} may represent noise predicted by the noise prediction model, θ denotes a parameter of the noise prediction model, ∇_{θ} denotes a gradient for the parameter θ, αₜ denotes a noise injection ratio at time t, ∈ denotes actual injected noise, and ∈₀ denotes noise predicted from the noise prediction model.

By training the noise prediction model through operations 310 to 370, the training apparatus of one or more embodiments may improve the extrapolation ability of the noise prediction model compared to the extrapolation ability of a typical model. Extrapolation ability may be an ability to make predictions for inputs outside the range of training data used for training. The noise prediction model of one or more embodiments with improved extrapolation ability may generate output images of a predetermined size without being restricted by aspect ratio, and may output output images with a higher resolution (e.g., four times the resolution of the training images used for training) than the training images used for training.

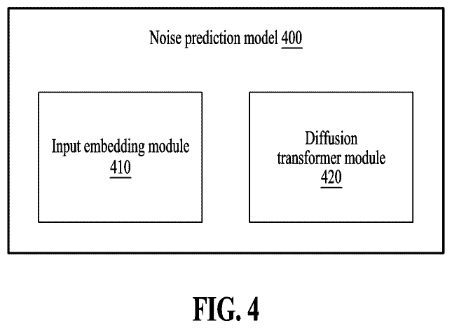

FIG. 4 illustrates an example of a noise prediction model, according to one or more embodiments.

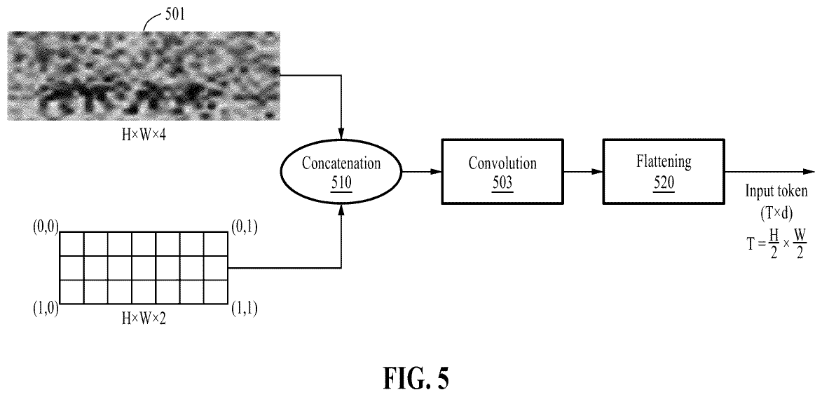

Referring to FIG. 4, a noise prediction model 400 may include an input embedding module 410 and a diffusion transformer module 420. The input embedding module 410 and the diffusion transformer module 420 may be connected. The input embedding module 410 may generate a feature map from an input image and generate a coordinate combined feature map by concatenating the feature map and a coordinate map. One or more examples of the input embedding module 410 are described in more detail with reference to FIG. 5. The diffusion transformer module 420 may predict noise in the feature map using an attention process and ultimately generate a target image based on the predicted noise. One or more examples of the generating of a target image by the diffusion transformer module 420 are described in detail with reference to FIG. 1, so a repeated description thereof is omitted. One or more examples of the attention process performed by the diffusion transformer module 420 are described in more detail with reference to FIG. 6.

FIG. 5 illustrates an example of an input embedding module of a noise prediction model, according to one or more embodiments.

Referring to FIG. 5, an input embedding module (e.g., the input embedding module 410 of FIG. 4) may output an input token using a feature map and a coordinate map of an input image. The input embedding module may determine at least one token from the feature map based on performing a convolution 503 operation on the coordinate combined feature map. The input embedding module may generate a feature map from an input image and generate a coordinate combined feature map by concatenating the feature map and a coordinate map. For example, the input embedding module may generate a coordinate combined feature map by performing an operation of concatenating 510 a feature map 501 and a coordinate map 502 generated from an input image. The coordinate map 502 may have vertices (0,0), (0,1), (1,0), and (1,1). The feature map 501 generated from the input image may have a size of H×W×4, and the coordinate map 502 may have a size of H×W×2.

The input embedding module may perform the convolution 503 operation on the coordinate combined feature map. By performing padding processing on the coordinate combined feature map and performing the convolution 503 operation on the coordinate combined feature map on which the padding processing is performed using the input embedding module, the apparatus of one or more embodiments may advantageously reduce an amount of required computations and improve processing speed by avoiding the embedding of each token individually. By performing the convolution 503 operation on the coordinate combined feature map on which the padding processing is performed, location information and context information related to features included in the feature map may be input together to the noise prediction model, and the apparatus of one or more embodiments may thereby improve the extrapolation ability of the noise prediction model and generate a higher-resolution output image.

The input embedding module may flatten 520 a result of performing the convolution 503 operation. The flattening 520 may be a process of transforming a result of performing the convolution 503 operation into a low-dimensional vector (e.g., one dimension). In response to the flattening 520, the input embedding module may generate (H/2)×(W/2) tokens, and generate input tokens with dimension d, which consist of (H/2)×(W/2) tokens.

FIG. 6 illustrates an example of an attention process performed in a diffusion noise prediction model, according to one or more embodiments.

Referring to FIG. 6, a noise prediction model may generate an attention output by mapping each token included in at least one token 601 (e.g., the input tokens generated in FIG. 5) to a query, a key, and a value, and performing an attention operation for each token based on the query, key, and value.

The noise prediction model may use linear projection to determine the query, key, and value. When the noise prediction model uses a process in which a convolution operation is performed on a result of a padding operation, point-wise linear projection used in multi-head self-attention may be replaced with linear projection and surrounding area information may be integrated, and the noise prediction model of one or more embodiments based on linear projection may thereby have an improved extrapolation ability and an improved ability to generate high-resolution output images. To reduce the size of parameters, the noise prediction model may use depth-wise separable convolution.

The noise prediction model may generate the at least one token 601 of the feature map based on the coordinate combined feature map. For example, the noise prediction model may generate the at least one token 601 by performing convolution on the coordinate combined feature map.

The noise prediction model may generate at least one output token 602 by performing attention on the at least one token 601. For example, the noise prediction model may generate the at least one output token 602 based on performing self-attention on the at least one token 601. The process of generating the at least one output token 602 by the noise prediction model performing attention may be as follows.

In operation 610, the noise prediction model may reshape an input token into a two-dimensional token. For example, the noise prediction model may reshape a one-dimensional input token into a two-dimensional or three-dimensional token.

In operation 620, the noise prediction model may generate a query Q, a key K, and a value V by performing a depth-wise separable convolution (DSC) operation on the dimensionally transformed input token. The DSC operation may be a type of convolution operation that separately performs a depth-wise convolution operation that independently performs convolution for each channel and a point-wise convolution operation that combines information between each channel.

In operation 630, the noise prediction model may generate an attention output by performing attention (e.g., self-attention) using the query Q, key K, and value V. An attention mechanism may process information more effectively by adjusting an attention distribution so that the query may focus more on particular elements within a sequence input. An attention operation may typically include matrix transformation of inputs (query Q, key K, value V), attention score determination, and attention output generation. Matrix transformation may be a process of generating an attention score matrix by performing a dot product operation between a query Q and a key K. Attention score determination may be a process of determining an attention weight by applying a softmax function to an determined attention score matrix. Attention output generation may be a process of generating a final output by applying a weighted sum to the attention score matrix based on the attention weight.

In operation 640, the noise prediction model may perform DSC on the attention output. The DSC performed on the attention output may be identical to the DSC performed in operation 620. The noise prediction model may map the attention output to the at least one output token 602. The noise prediction model may map a result of reshaping the attention output on which the DSC is performed to the at least one output token 602.

FIG. 7 illustrates an example of a training apparatus, according to one or more embodiments.

Referring to FIG. 7, the training apparatus 700 may include a feature generator 710, a coordinate concatenator 720, a noise predictor 730, and a parameter adjustor 740.

The feature generator 710 may generate a feature map including noise of a training image within a training image set. The feature map including noise may be generated by adding actual noise to the feature map of the training image. The feature generator 710 may select a training image group from a training image set during a training process for training a noise prediction model. The feature generator 710 may generate a training image by sampling training images from a training image group. An aspect ratio of a training image sampled from a first training image group may be a first aspect ratio, and an aspect ratio of a training image sampled from a second training image group may be a second aspect ratio. The first aspect ratio may be greater than the second aspect ratio.

The feature generator 710 may preprocess the training image. The feature generator 710 may perform at least one of a first preprocessing performed according to a first performance probability indicating a probability that preprocessing is to be performed and a second preprocessing performed according to a second performance probability different from the first performance probability. The first preprocessing performed according to the first performance probability may be dividing a center of a training image into blocks of a predetermined size. The second preprocessing performed according to the second performance probability may be adjusting a size of a training image to be less than or equal to a threshold value by adjusting a height of the training image to a predetermined length and adjusting a width of the training image to correspond to the predetermined height while maintaining an aspect ratio of the training image.

The coordinate concatenator 720 may generate a coordinate combined feature map by concatenating the feature map including noise and a coordinate map indicating a location of a feature point of the feature map including noise.

Based on the coordinate combined feature map of the noise predictor 730, predicted noise may be generated from a noise prediction model that predicts noise of the feature map. The noise predictor 730 may determine at least one token from the feature map based on performing a convolution operation on the coordinate combined feature map, and generate at least one output token by performing an attention operation on the at least one token. The noise predictor 730 may predict noise using a noise prediction model to which at least one output token is input.

The noise predictor 730 may generate an attention operation result token by mapping each token included in the at least one token to a query, a key, and a value, and performing an attention operation for each token based on the query, key, and value. The noise predictor 730 may map the attention operation result token to the at least one output token. The noise predictor 730 may generate a first noise, which is a result of predicting noise of the feature map from the noise prediction model to which at least one output token is input, and generate a first denoised feature map based on the feature map and the first noise. The noise predictor 730 may generate a second denoised feature map by enlarging the first denoised feature map to a predetermined size, and generate a feature map to which a second noise is added by adding noise to the second denoised feature map. The noise predictor 730 may generate the second noise based on a difference between the first denoised feature map and the feature map to which the second noise is added, and determine the second noise as noise of the feature map including noise.

The parameter adjustor 740 may train the noise prediction model by adjusting at least one parameter included in the noise prediction model based on reducing a difference between the predicted noise and the noise added to the feature map.

FIG. 8 illustrates an example of an image generation apparatus, according to one or more embodiments.

Referring to FIG. 8, the image generation apparatus 800 may include a feature generator 810, a coordinate concatenator 820, a noise predictor 850, a feature denoiser 860, and an image generator 870.

The feature generator 810 may generate a feature map from an input image.

The coordinate concatenator 820 may generate a coordinate combined feature map by concatenating the feature map and a coordinate map indicating a location of a feature point of the feature map. The coordinate map may be used to provide location information of feature points within a feature map.

The noise predictor 850 may predict noise using a noise prediction model that predicts noise in a feature map, based on the coordinate combined feature map. At least one token may be determined from the feature map based on performing a convolution operation on the coordinate combined feature map, and at least one output token may be generated by performing an attention operation on the at least one token. The noise predictor 850 may predict noise using a noise prediction model to which at least one output token is input, and generate a first noise, which is a result of predicting noise of the feature map from the noise prediction model to which at least one output token is input. The noise predictor 850 may generate a first denoised feature map based on the feature map and the first noise, and generate a second denoised feature map by enlarging the first denoised feature map to a predetermined size. The noise predictor 850 may generate a feature map to which noise is added by adding noise to the second denoised feature map, and generate a second noise based on a difference between the first denoised feature map and the feature map to which noise is added. The noise predictor 850 may determine the second noise as noise of the feature map.

The feature denoiser 860 may generate a denoised feature map by denoising the feature map based on the predicted noise.

The image generator 870 may generate a target image based on the denoised feature map.

FIG. 9 illustrates an example of components of an image generation apparatus, according to one or more embodiments. Referring to FIG. 9, an image generation apparatus 900 may include memory 910 and a processor 920.

The memory 910 may store instructions executable by the processor 920. When executed by the processor 920, the instructions executable by the processor 920 may cause the processor 920 to perform an image generation method. For example, the memory 910 may be or include a non-transitory computer-readable storage medium storing instructions that, when executed by the processor 920, configure the processor 920 to perform any one, any combination, or all of the operations and/or methods disclosed herein with reference to FIGS. 1-10. The memory 910 may be integrated with the processor 920. For example, random-access memory (RAM) or flash memory may be integrated with the processor 920 such as an integrated circuit microprocessor. The memory 910 may include a separate device, such as a storage device that may be used by an external disk drive, a storage array, or a database system. The memory 910 and the processor 920 may be operatively integrated or may communicate with each other via an input/output (I/O) port, a network connection or the like, so that the processor 920 may read a file stored in the memory 910. The memory 910 may be a non-transitory computer-readable storage medium that stores instructions. When executed by the processor 920, the instructions stored in the memory 910 may prompt at least one processor 920 to cause the image generation apparatus 900 to perform the image generation method.

The non-transitory computer-readable storage medium may include read-only memory (ROM), programmable ROM (PROM), electrically erasable PROM (EEPROM), RAM, dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, a hard disk drive (HDD), a solid state drive (SSD), card memory (e.g., a multimedia card, a secure digital (SD) card, or an extreme digital (XD) card), magnetic tape, a floppy disk, a magneto-optical data storage device, an optical data storage device, a hard disk, a solid state disk, and other devices.

The processor 920 may execute instructions stored in the memory 910. The processor 920 may include a central processing unit (CPU), a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an application-specific integrated circuit (ASIC), a field programmable gate array (FPGA), or any combination thereof. When the instructions are executed by the processor 920, the processor 920 may control the image generation apparatus 900 to perform operations of the image generation method described in the present disclosure.

The image generation apparatus 900 may generate a feature map from an input image, generate a coordinate combined feature map by concatenating the feature map and a coordinate map indicating a location of a feature point of the feature map, predict noise using a noise prediction model that predicts noise of the feature map, based on the coordinate combined feature map, generate a denoised feature map by denoising the feature map based on the predicted noise, and generate a target image based on the denoised feature map.

The image generation apparatus 900 may determine at least one token from the feature map by performing a convolution operation on the coordinate combined feature map, generate at least one output token by performing an attention operation on the at least one token, and generate the predicted noise from the noise prediction model to which the at least one output token is input.

The image generation apparatus 900 may map each token included in the at least one token to a query, a key and a value, generate an attention output by performing an attention operation on each token based on the query, the key and the value, and map the attention output to the at least one output token.

The image generation apparatus 900 may generate a first noise which is a result of predicting noise of the feature map from the noise prediction model to which the at least one output token is input, generate a first denoised feature map based on the feature map and the first noise, generate a second denoised feature map by enlarging the first denoised feature map to a predetermined size, generate a feature map to which noise is added by adding noise to the second denoised feature map, generate a second noise based on a difference between the first denoised feature map and the feature map to which noise is added, and determine the second noise as noise of the feature map.

The image generation apparatus 900 may generate a target image by decoding the denoised feature map using a VAE.

The image generation method performed by the image generation apparatus 900 may be provided by executing a non-transitory computer-readable storage medium. For example, when a non-transitory computer-readable storage medium is executed, the image generation method including generating a feature map from an input image, generating a coordinate combined feature map by concatenating the feature map and a coordinate map indicating a location of a feature point of the feature map, predicting noise using the noise prediction model that predicts noise of the feature map, based on the coordinate combined feature map, generating a denoised feature map by denoising the feature map based on the predicted noise, and generating a target image based on the denoised feature map may be executed. The non-transitory computer-readable storage medium may include, but is not limited to, an electronic, magnetic, optical, electromagnetic, infrared, or semiconductor system, device, or equipment, or any suitable combination thereof. In embodiments of the disclosure, the non-transitory computer-readable storage medium may be an arbitrary type of medium that includes or stores a computer program that may be used by or in conjunction with an instruction execution system, device, or element. A computer program included in the non-transitory computer-readable storage medium may be transmitted using any suitable medium, including but not limited to wires, optical cables, radio frequency (RF), or the like, or any suitable combination thereof. The non-transitory computer-readable storage medium may be included in an arbitrary device and may exist independently without being assembled into the device. In addition, according to embodiments of the disclosure, a computer program product may be further included, and instructions of the computer program product may be executed by a processor of a computer device to implement a model quantization method.

FIG. 10 illustrates an example of components of a training apparatus, according to one or more embodiments. Referring to FIG. 10, a training apparatus 1000 may include memory 1010 and a processor 1020. In an example, the training apparatus 1000 may be or be included in the image generation apparatus 900 of FIG. 9, the memory 1010 may be or be included in the memory 910 of FIG. 9, and the processor 1020 may be or be included in the processor 920 of FIG. 9.

The memory 1010 may store instructions executable by the processor 1020. When executed by the processor 1020, the instructions executable by the processor 1020 may cause the processor 1020 to perform operations of a training method for training a noise prediction model. For example, the memory 1010 may be or include a non-transitory computer-readable storage medium storing instructions that, when executed by the processor 1020, configure the processor 1020 to perform any one, any combination, or all of the operations and/or methods disclosed herein with reference to FIGS. 1-10. The memory 1010 may be integrated with the processor 1020. For example, RAM or flash memory may be integrated with the processor 1020 such as an integrated circuit microprocessor. The memory 1010 may include a separate device, such as a storage device that may be used by an external disk drive, a storage array, or a database system. The memory 1010 and the processor 1020 may be operatively integrated or may communicate with each other via an I/O port, a network connection, or the like so that the processor 1020 may read a file stored in the memory 1010. The memory 1010 may be a non-transitory computer-readable storage medium that stores instructions. When executed by the processor 1020, the instructions stored in the memory 1010 may prompt at least one processor 1020 to cause the training apparatus 1000 to perform operations of a training method for training a noise prediction model.

The non-transitory computer-readable storage medium may include read-only memory (ROM), programmable ROM (PROM), electrically erasable PROM (EEPROM), RAM, dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, a hard disk drive (HDD), a solid state drive (SSD), card memory (e.g., a multimedia card, a secure digital (SD) card, or an extreme digital (XD) card), magnetic tape, a floppy disk, a magneto-optical data storage device, an optical data storage device, a hard disk, a solid state disk, and other devices.

The processor 1020 may execute the instructions stored in the memory 1010. The processor 1020 may include a CPU, a GPU, an NPU, an MPU, a DPU, a VPU, a video processor, an image processor, a display processor, a microprocessor, a processor core, a multi-core processor, an ASIC, an FPGA, or any combination thereof. When the instructions are executed by the processor 1020, the processor 1020 may control the training apparatus 1000 to perform operations of a training method for training the noise prediction model described in the present disclosure.

The training apparatus 1000 may generate a feature map to which a first noise is added by adding noise to a feature map generated from a training image selected from a training image set, generate a coordinate combined feature map by concatenating the feature map including the noise and a coordinate map indicating a location of a feature point of the feature map including the noise, predict noise using a noise prediction model that predicts noise of the feature map, based on the coordinate combined feature map, and train the noise prediction model based on the predicted noise and the noise added to the feature map.

The training apparatus 1000 may train the noise prediction model by adjusting at least one parameter included in the noise prediction model based on reducing a difference between the predicted noise and the noise added to the feature map.

The training apparatus 1000 may determine at least one token from the feature map by performing a convolution operation on the coordinate combined feature map, generate at least one output token by performing an attention operation on the at least one token, and generate the predicted noise from the noise prediction model to which the at least one output token is input.

The training apparatus 1000 may generate an attention operation result token by mapping each token included in the at least one token to a query, a key, and a value, and performing an attention operation for each token based on the query, key, and value, and map the attention operation result token to at least one output token.

The training apparatus 1000 may generate a first noise which is a result of predicting noise of the feature map from the noise prediction model to which the at least one output token is input, generate a first denoised feature map based on the feature map and the first noise, generate a second denoised feature map by enlarging the first denoised feature map to a predetermined size, generate a feature map to which a second noise is added by adding noise to the second denoised feature map, generate a second noise based on a difference between the first denoised feature map and the feature map to which the second noise is added, and determine the second noise as noise of the feature map including noise.

The training apparatus 1000 may generate a training image from a training image set by selecting at least one training image group from the training image set and sampling an image included in the training image group. The training image group may include a first training image group and a second training image group different from the first training image group, an image included in the first training image group may have a first aspect ratio, an image included in the second training image group may have a second aspect ratio, and the first aspect ratio may be greater than the second aspect ratio.

The training apparatus 1000 may preprocess a training image by performing at least one of a first preprocessing performed according to a first performance probability indicating a probability that preprocessing is to be performed and a second preprocessing performed according to a second performance probability different from the first performance probability. The first preprocessing performed according to the first performance probability may be dividing a center of a training image into blocks of a predetermined size. The second preprocessing performed according to the second performance probability may be adjusting a size of a training image to be less than or equal to a threshold value by adjusting a height of the training image to a predetermined length and adjusting a width of the training image to correspond to the predetermined height while maintaining an aspect ratio of the training image.

The training apparatuses, feature acquirers, coordinate concatenators, noise predictors, parameter adjustors, image generation apparatuses, feature acquirers, coordinate concatenators, noise predictors, feature denoisers, image generators, image generation apparatuses, memories, processors, training apparatuses, memories, processors, training apparatus 700, feature generator 710, coordinate concatenator 720, noise predictor 730, parameter adjustor 740, image generation apparatus 800, feature generator 810, coordinate concatenator 820, noise predictor 850, feature denoiser 860, image generator 870, image generation apparatus, memory 910, processor 920, training apparatus 1000, memory 1010, processor 1020, described herein, including descriptions with respect to respect to FIGS. 1-10, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-10 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An apparatus comprising:
one or more processors comprising processing circuitry; and
memory comprising one or more storage media storing instructions that, when executed individually or collectively by the one or more processors, cause the apparatus to:
generate a feature map from an input image;
generate a coordinate combined feature map by concatenating the feature map and a coordinate map indicating a location of a feature point of the feature map;
predict noise of the feature map using a noise prediction model, based on the coordinate combined feature map;
generate a denoised feature map by denoising the feature map based on the predicted noise; and
generate a target image based on the denoised feature map.

2. The apparatus of claim 1, wherein, for the predicting of the noise, the execution of the instructions causes the apparatus to:
determine one or more input tokens from the feature map by performing a convolution operation on the coordinate combined feature map;
determine one or more output tokens by performing an attention operation on the one or more input tokens; and
predict the predicted noise using the noise prediction model to which the one or more output tokens is input.

3. The apparatus of claim 2, wherein, for the determining of the one or more output tokens, the execution of the instructions causes the apparatus to:
map each token comprised in the one or more input tokens to a query, a key and a value,
determine an attention output by performing an attention operation on each token based on the query, the key and the value; and
map the attention output to the one or more output tokens.

4. The apparatus of claim 2, wherein, for the predicting of the noise, the execution of the instructions causes the apparatus to:
predict a first noise of the feature map using the noise prediction model to which the one or more output tokens is input;
generate a first denoised feature map based on the feature map and the first noise;
generate a second denoised feature map by enlarging the first denoised feature map to a predetermined size;
generate a feature map to which noise is added by adding noise to the second denoised feature map;
determine a second noise based on a difference between the first denoised feature map and the feature map to which noise is added; and
determine the second noise as noise of the feature map.

5. The apparatus of claim 2, wherein, for the determining of the one or more input tokens, the execution of the instructions causes the apparatus to:
perform padding on the coordinate combined feature map; and
perform the convolution operation on the padded coordinate combined feature map.

6. The apparatus of claim 5, wherein, for the determining of the one or more input tokens, the execution of the instructions causes the apparatus to determine the one or more input tokens by transforming a result of the convolution operation into a lower-dimensional vector.

7. The apparatus of claim 1, wherein, for the generating of the target image, the execution of the instructions causes the apparatus to generate the target image by decoding the denoised feature map using a variational autoencoder (VAE).

8. The apparatus of claim 1, wherein
the feature map is generated by adding noise to a feature map acquired from a training image selected from a training image set, and
the execution of the instructions causes the apparatus to train the noise prediction model based on the predicted noise and the noise added to the feature map.

9. An apparatus comprising:
one or more processors comprising processing circuitry; and
memory comprising one or more storage media storing instructions that, when executed individually or collectively by the one or more processors, cause the apparatus to:
generate a feature map to which a first noise is added by adding noise to a feature map acquired from a training image selected from a training image set;
generate a coordinate combined feature map by concatenating the feature map comprising the noise and a coordinate map indicating a location of a feature point of the feature map comprising the noise;
predict noise of the feature map using a noise prediction model, based on the coordinate combined feature map; and
train the noise prediction model based on the predicted noise and the noise added to the feature map.

10. The apparatus of claim 9, wherein, for the training of the noise prediction model, the execution of the instructions causes the apparatus to train the noise prediction model by adjusting one or more parameters comprised in the noise prediction model based on reducing a difference between the predicted noise and the noise added to the feature map.

11. The apparatus of claim 9, wherein, for the predicting of the noise, the execution of the instructions causes the apparatus to:
determine one or more input tokens from the feature map based on performing a convolution operation on the coordinate combined feature map;
determine one or more output tokens by performing an attention operation on the one or more input tokens; and
determine the predicted noise from the noise prediction model to which the one or more output tokens is input.

12. The apparatus of claim 11, wherein, for the determining of the one or more output tokens, the execution of the instructions causes the apparatus to:
map each token comprised in the one or more input tokens to a query, a key and a value;
determine an attention operation result token by performing an attention operation on each token based on the query, the key, and the value; and
map the attention operation result token to the one or more output tokens.

13. The apparatus of claim 12, wherein, for the predicting of the noise, the execution of the instructions causes the apparatus to:
predict a first noise which is a result of predicting noise of the feature map from the noise prediction model to which the one or more output tokens is input;
generate a first denoised feature map based on the feature map and the first noise;
generate a second denoised feature map by enlarging the first denoised feature map to a predetermined size;
generate a feature map to which a second noise is added by adding noise to the second denoised feature map;
determine the second noise based on a difference between the first denoised feature map and the feature map to which the second noise is added; and
determine the second noise as noise of the feature map comprising the noise.

14. The apparatus of claim 9, wherein the execution of the instructions causes the apparatus to:
select one or more training image groups from the training image set; and
generate the training image from the training image set by sampling an image comprised in the training image group,
wherein the training image group comprises a first training image group and a second training image group different from the first training image group, and
an image comprised in the first training image group has a first aspect ratio, an image comprised in the second training image group has a second aspect ratio, and the first aspect ratio is greater than the second aspect ratio.

15. The apparatus of claim 9, wherein the execution of the instructions causes the apparatus to:
preprocess the training image by performing either one or both of a first preprocessing performed according to a first performance probability indicating a probability that preprocessing is to be performed and a second preprocessing performed according to a second performance probability different from the first performance probability,
wherein the first preprocessing performed according to the first performance probability is dividing a center of the training image into blocks of a predetermined size, and
the second preprocessing performed according to the second performance probability adjusts a size of the training image to be less than or equal to a threshold value by adjusting a height of the training image to a predetermined length and adjusting a width of the training image to correspond to the predetermined height while maintaining an aspect ratio of the training image.

16. A processor-implemented method comprising:
generating a feature map from an input image;
generating a coordinate combined feature map by concatenating the feature map and a coordinate map indicating a location of a feature point of the feature map;
predicting noise of the feature map using a noise prediction model, based on the coordinate combined feature map;
generating a denoised feature map by denoising the feature map based on the predicted noise; and
generating a target image based on the denoised feature map.

17. The method of claim 16, wherein the predicting of the noise comprises:
determining one or more input tokens from the feature map by performing a convolution operation on the coordinate combined feature map;
determining one or more output tokens by performing an attention operation on the one or more input tokens; and
predicting the predicted noise using the noise prediction model to which the at least one output token is input.

18. The method of claim 17, wherein the determining of the one or more output tokens comprises:
mapping each token comprised in the one or more input tokens to a query, a key and a value;
determining an attention output by performing an attention operation on each token based on the query, the key and the value; and
mapping the attention output to the one or more output tokens.

19. The method of claim 17, wherein the predicting of the noise comprises:
predicting a first noise of the feature map using the noise prediction model to which the one or more output tokens is input;
generating a first denoised feature map based on the feature map and the first noise;
generating a second denoised feature map by enlarging the first denoised feature map to a predetermined size;
generating a feature map to which noise is added by adding noise to the second denoised feature map;
determining a second noise based on a difference between the first denoised feature map and the feature map to which noise is added; and
determining the second noise as noise of the feature map.

20. A non-transitory computer-readable storage medium storing instructions that, when executed by one or more processors, configure the one or more processors to perform the method of claim 16.
